(19) United States
(12) Patent Application Publication
(10) Pub. No.: US 2025/0326225 A1
(43) Pub. Date: Oct. 23, 2025

(54) LIQUID DISCHARGE HEAD AND RECORDING DEVICE

(71) Applicant: KYOCERA Corporation, Kyoto (JP)

(72) Inventors: Toru NAKAJIMA, Kyotanabe -shi, Kyoto (JP); Kazuki DOGOME, Kirishima-shi, Kagoshima (JP)

(21) Appl. No.: 18/851,651

(22) PCT Filed: Mar. 27, 2023
(86) PCT No.: PCT/JP2023/012222

§ 371 Date: Sep. 26, 2024

(30) Foreign Application Priority Data
Mar. 29, 2022 (JP) 2022-054517

(51) Int. Cl. B41J 2/14

(52) U.S. Cl. CPC B41J 2/14233; B41J 2002/14306; B41J 2002/14491

(57) ABSTRACT

A liquid discharge head includes a vibration plate, a plurality of pressure chambers, a plurality of piezoelectric elements, and a sealing member. The vibration plate includes a first surface and a second surface positioned opposite to the first surface. The plurality of pressure chambers face the first surface and are positioned side by side in one direction. The plurality of piezoelectric elements are positioned on the second surface and respectively overlap the plurality of pressure chambers in plan view. The sealing member is a sealing member having a frame shape, the sealing member being positioned on the second surface and surrounding the plurality of piezoelectric elements.

### CROSS-REFERENCE TO RELATED APPLICATIONS

This application is a national stage entry according to 35 U.S.C. 371 of PCT Application No. PCT/JP2023/012222 filed on Mar. 27, 2023, which claims priority to Japanese Patent Application No. 2022-054517, filed on Mar. 29, 2022.

### TECHNICAL FIELD The disclosed embodiments relate to a liquid discharge head and a recording device.

### BACKGROUND OF INVENTION

A known printing device that is a recording device configured to record images and characters includes an inkjet printer or an inkjet plotter that utilizes an inkjet recording system. A liquid discharge head for discharging a liquid is mounted onto such a printing device (recording device) of an inkjet system.

In such a liquid discharge head, a sealing member is provided on a vibration plate provided with a plurality of piezoelectric elements for discharging liquid and individually surrounds each piezoelectric element, thereby protecting each piezoelectric element from liquid leakage from a channel and moisture in the outside air (for example, see Patent Document 1).

### CITATION LIST

### PATENT LITERATURE

Patent Document 1: JP 2021-176710 A

### SUMMARY

In an aspect of an embodiment, a liquid discharge head includes a vibration plate, a plurality of pressure chambers, a plurality of piezoelectric elements, and a sealing member. The vibration plate includes a first surface and a second surface positioned opposite to the first surface. The plurality of pressure chambers face the first surface and are positioned side by side in one direction. The plurality of piezoelectric elements are positioned on the second surface and respectively overlap the plurality of pressure chambers in plan view. The sealing member is a sealing member having a frame shape, the sealing member being positioned on the second surface and surrounding the plurality of piezoelectric elements.

### BRIEF DESCRIPTION OF THE DRAWINGS

FIG. 1 is a front view schematically illustrating an overall front of a printer according to an embodiment.

FIG. 2 is a plan view schematically illustrating an overall plane of the printer according to the embodiment.

FIG. 3 is a plan view illustrating a schematic configuration of a liquid discharge head according to the embodiment.

FIG. 4 is a cross-sectional view taken along line IV-IV illustrated in FIG. 3.

FIG. 5 is a plan view illustrating a schematic configuration of the liquid discharge head according to a first alternate embodiment.

FIG. 6A is a plan view illustrating a schematic configuration of the liquid discharge head according to a second alternate embodiment.

FIG. 6B is a plan view illustrating a schematic configuration of the liquid discharge head according to a third alternate embodiment.

FIG. 7 is a cross-sectional view taken along line VII-VII illustrated in FIG. 6A or FIG. 6B.

### DESCRIPTION OF EMBODIMENTS

Embodiments of a liquid discharge head and a recording device disclosed in the present application will be described in detail below with reference to the accompanying drawings. Note that the present disclosure is not limited by the following embodiments. The drawings are schematic, and dimensional relationships between elements, proportions of the elements, and the like may differ from the actual ones. There may be differences between the drawings in terms of dimensional relationships and proportions.

In the following embodiments, expressions such as “constant”, “orthogonal”, “perpendicular”, and “parallel” may be used, but these expressions do not mean exactly “constant”, “orthogonal”, “perpendicular”, and “parallel”. That is, it is assumed that the above expressions allow for deviations in manufacturing accuracy and installation accuracy, for example.

### Embodiment

### Configuration of Printer

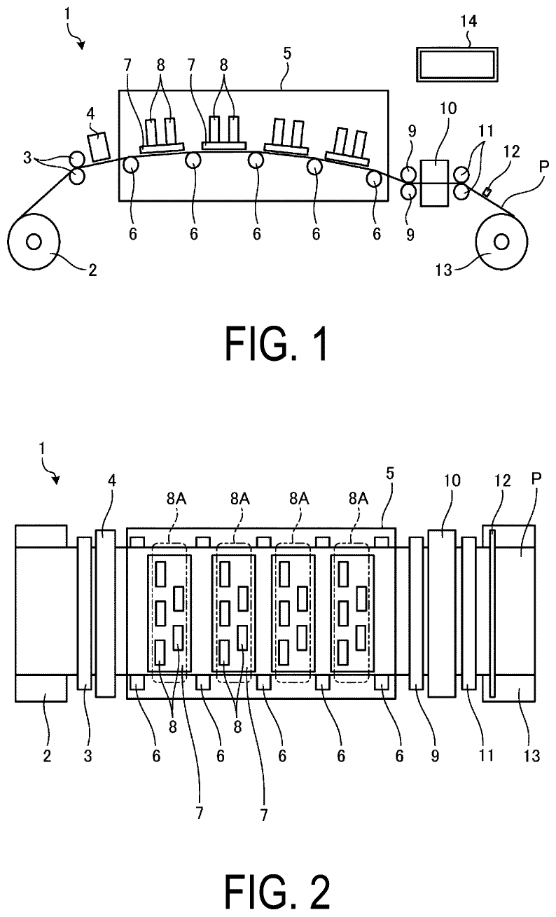

Using FIGS. 1 and 2, description will be given of an overview of a printer 1 serving as an example of a recording device according to an embodiment. FIG. 1 is a front view schematically illustrating an overall front of the printer 1 according to the embodiment. FIG. 2 is a plan view schematically illustrating an overall plane of the printer 1 according to the embodiment. The printer 1 according to the embodiment is, for example, a color inkjet printer including an inkjet head that is a liquid discharge head.

As illustrated in FIG. 1, the printer 1 includes a paper feed roller 2, guide rollers 3, an applicator 4, a head case 5, a plurality of transport rollers 6, a plurality of frames 7, a plurality of liquid discharge heads 8, transport rollers 9, a dryer 10, transport rollers 11, a sensor portion 12, and a collection roller 13.

The printer 1 further includes a controller 14 configured to control each portion of the printer 1. The controller 14 controls operations of the paper feed roller 2, the guide rollers 3, the applicator 4, the head case 5, the plurality of transport rollers 6, the plurality of frames 7, the plurality of liquid discharge heads 8, the transport rollers 9, the dryer 10, the transport rollers 11, the sensor portion 12, and the collection roller 13.

The printer 1 records an image and a character on a printing sheet P by causing droplets discharged from the liquid discharge heads 8 to land on the printing sheet P. The printing sheet P is wound around the paper feed roller 2 in a drawable state before use. The printer 1 transports the printing sheet P from the paper feed roller 2 to the inside of the head case 5 via the guide rollers 3 and the applicator 4.

The applicator 4 uniformly applies a coating agent over the printing sheet P. Thus, a surface treatment can be performed on the printing sheet P, and the printing quality of the printer 1 can therefore be improved.

The head case 5 houses the plurality of transport rollers 6, the plurality of frames 7, and the plurality of liquid discharge heads 8. The inside of the head case 5 is formed with a space separated from the outside except for portions connected to the outside such as portions from which the printing sheet P enters and exits the head case 5.

The controller 14 controls at least one of controllable factors of the internal space of the head case 5, such as temperature, humidity, and air pressure, as necessary. The transport rollers 6 transport the printing sheet P to the vicinity of the liquid discharge heads 8 inside the head case 5.

The frames 7 are, for example, rectangular flat plates and are positioned above and in close proximity to the printing sheet P transported by the transport rollers 6. As illustrated in FIG. 2, the frames 7 are positioned having a longitudinal direction orthogonal to a transport direction of the printing sheet P. Inside the head case 5, the plurality of (for example, 4) frames 7 are positioned at predetermined intervals along the transport direction of the printing sheet P.

In the following description, the transport direction of the printing sheet P may be referred to as a “sub-scanning direction”, and the direction orthogonal to the sub-scanning direction and parallel to the printing sheet P may be referred to as a “main scanning direction”.

The liquid discharge head 8 is a so-called circulating liquid discharge head that discharges liquid while circulating the liquid inside the liquid discharge head. A liquid, for example, ink, is supplied to the liquid discharge head 8 from a liquid tank (not illustrated) of a circulation device. The liquid discharge head 8 discharges the liquid supplied from the liquid tank of the circulation device. The liquid discharge head 8 recovers the liquid that is not discharged and feeds the liquid thus recovered to the liquid tank of the circulation device.

The controller 14 controls the liquid discharge head 8 based on data such as an image and a character to discharge a liquid (droplets) toward the printing sheet P. A distance between the liquid discharge heads 8 and the printing sheet P is, for example, approximately from 0.5 mm to 20 mm.

The liquid discharge heads 8 are fixed to the frames 7. For example, both end portions of the liquid discharge heads 8 in the longitudinal direction are fixed to the frames 7. The liquid discharge heads 8 are fixed to the frames 7 such that the longitudinal direction of the liquid discharge heads 8 is parallel to the main scanning direction.

That is, the printer 1 according to the embodiment is a so-called line printer in which the liquid discharge heads 8 are fixed inside the printer 1. Note that the printer 1 according to the embodiment is not limited to the line printer and may also be a so-called serial printer.

The serial printer is a printer employing a method of alternately performing an operation of recording while moving the liquid discharge heads 8 so as to cause the liquid discharge heads 8 to reciprocate in a direction intersecting (for example, substantially orthogonal to) the transport direction of the printing sheet P, and an operation of transporting the printing sheet P.

As illustrated in FIG. 2, a plurality of (for example, five) liquid discharge heads 8 are provided in one of the frames 7. FIG. 2 illustrates an example in which two of the liquid discharge heads 8 are disposed on the upstream side of the sub-scanning direction and three of the liquid discharge heads 8 are disposed on the downstream side of the sub-scanning direction, and the liquid discharge heads 8 are arranged such that centers of the liquid discharge heads 8 do not overlap with each other in the sub-scanning direction.

The plurality of liquid discharge heads 8 provided in one of the frames 7 form a head group 8A. Four of the head groups 8A are positioned in the sub-scanning direction. The liquid discharge heads 8 belonging to the same head group 8A are supplied with ink of the same color. Thus, the printer 1 can perform printing with four colors of ink using the four head groups 8A.

The colors of the ink discharged from the respective head groups 8A are, for example, magenta (M), yellow (Y), cyan (C), and black (K). The controller 14 can print a color image on the printing sheet P by controlling the respective head groups 8A to discharge the plurality of colors of ink onto the printing sheet P.

Note that a coating agent may be discharged from the liquid discharge heads 8 onto the printing sheet P to perform a surface treatment on the printing sheet P.

The number of the liquid discharge heads 8 included in one of the head groups 8A and the number of the head groups 8A mounted in the printer 1 can be changed as appropriate in accordance with an object on which printing is to be performed or printing conditions. For example, when the color to be printed on the printing sheet P is a single color and the printing range can be covered by one of the liquid discharge heads 8 or the head groups 8A, only one of the liquid discharge heads 8 or the head groups 8A need to be mounted in the printer 1.

The printing sheet P on which the printing has been performed inside the head case 5 is transported to the outside of the head case 5 by the transport rollers 9 and passes through the inside of the dryer 10. The dryer 10 dries the printing sheet P on which the printing has been performed. The printing sheet P dried by the dryer 10 is transported by the transport rollers 11 and then collected by the collection roller 13.

In the printer 1, with the printing sheet P being dried using the dryer 10, bonding between the printing sheets P taken up by the collection roller 13 in an overlapped manner, or rubbing of an undried liquid on the collection roller 13 can be suppressed.

The sensor portion 12 includes, for example, a position sensor, a speed sensor, or a temperature sensor. Based on information from the sensor portion 12, the controller 14 can determine the state of each portion of the printer 1 and control each portion of the printer 1.

In the above-described printer 1, the printing sheet P is used as the printing target (that is, a recording medium), but the printing target in the printer 1 is not limited to the printing sheet P, and a rolled cloth or the like may be used as the printing target.

Instead of directly transporting the printing sheet P, the above-described printer 1 may have a configuration in which the printing sheet P is placed on a transporting belt and transported. By using the transporting belt, the printer 1 can use a sheet of paper, a cut cloth, wood, a tile, or the like as the printing target.

The above-described printer 1 may also discharge a liquid containing electrically conductive particles from the liquid discharge heads 8 to print a wiring pattern or the like of an electronic device.

The above-described printer 1 may also discharge a liquid containing a predetermined amount of a liquid chemical agent or of a liquid containing the chemical agent, from the liquid discharge heads 8 onto a reaction vessel or the like to produce chemicals.

The above-described printer 1 may also include a cleaner for cleaning the liquid discharge heads 8. The cleaner cleans the liquid discharge head 8 by, for example, a wiping process or a capping process.

The wiping process is, for example, a process of wiping a surface of a portion from which the liquid of the liquid discharge head 8 is discharged using a flexible wiper, thereby removing the liquid attached to the surface of the liquid discharge head 8.

The capping process is performed as follows, for example. First, a cap is placed to cover a portion from which the liquid of the liquid discharge head 8 is discharged, for example, a bottom surface 8e (see FIG. 4) of the liquid discharge head 8 (this is called capping). Thus, a substantially sealed space is formed between the bottom surface 8e and the cap.

The discharge of liquid is then repeated in such a hermetically sealed space. Thus, a liquid having a viscosity higher than that in a normal state, foreign matter, and the like that have clogged a nozzle 28 (see FIG. 4) can be removed.

### Configuration of Liquid Discharge Head

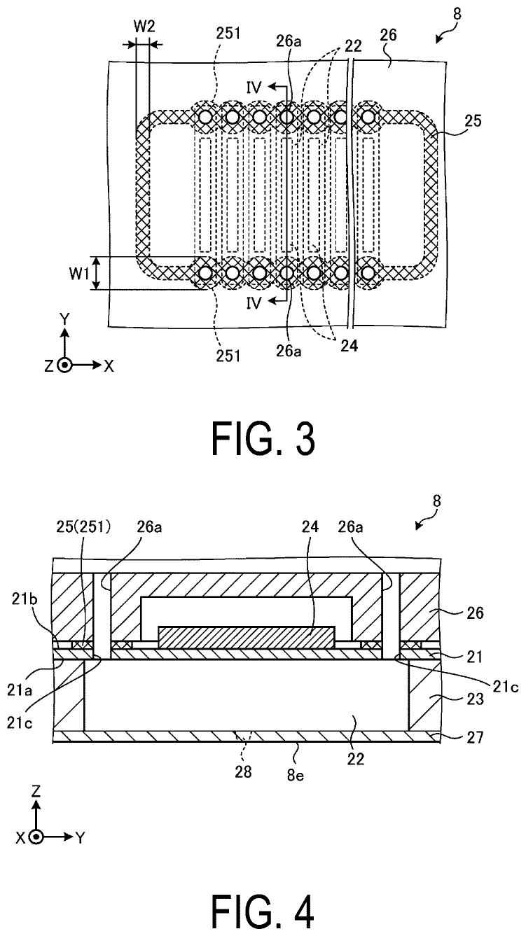

The configuration of the liquid discharge head 8 according to the embodiment will be described with reference to FIGS. 3 and 4. FIG. 3 is a plan view illustrating a schematic configuration of the liquid discharge head according to the embodiment. FIG. 4 is a cross-sectional view taken along line IV-IV illustrated in FIG. 3.

Note that, for the sake of clarity, FIG. 3 illustrates a three-dimensional orthogonal coordinate system including a Z axis in which a vertically upward direction is a positive direction. Such an orthogonal coordinate system may also be presented in other drawings used in the description below. In the following description, for convenience, a direction in which the bottom surface 8e (see FIG. 4) of the liquid discharge head 8 is positioned in the liquid discharge head 8, that is, a Z axis negative direction side may be referred to as “lower” or “downward”, and a Z axis positive direction side may be referred to as “upper” or “upward”.

As illustrated in FIGS. 3 and 4, the liquid discharge head 8 includes a vibration plate 21, a plurality of pressure chambers 22, a pressure chamber beam 23, a plurality of piezoelectric elements 24, a sealing member 25, a channel member 26, and a nozzle layer 27.

The vibration plate 21 is positioned on the plurality of pressure chambers 22 and the pressure chamber beam 23. The vibration plate 21 is, for example, a plate-shaped member made of silicon, and includes a first surface 21a which is one main surface and a second surface 21b positioned opposite to the first surface 21a.

The plurality of pressure chambers 22 face the first surface 21a of the vibration plate 21. Each pressure chamber 22 is a hollow region having a substantially rectangular planar shape with corner portions that are rounded. As illustrated in FIG. 3, the plurality of pressure chambers 22 are positioned side by side in the X axis direction with longitudinal directions thereof extending in the Y axis direction. The liquid is supplied inside each pressure chamber 22 via a channel 26a of the channel member 26 and an opening 21c (see FIG. 4) of the vibration plate 21.

The pressure chamber beam 23 is positioned around a periphery of each pressure chamber 22 and separates each pressure chamber 22 from the other pressure chambers 22.

The plurality of piezoelectric elements 24 are positioned respectively overlapping the plurality of pressure chamber 22 on the second surface 21b of the vibration plate 21 in plan view. Each piezoelectric element 24 is deformed and thus displaced in the Z axis direction (vertical direction) together with the vibration plate 21 by conduction, changing an internal pressure of the corresponding pressure chamber 22 via the vibration plate 21.

The sealing member 25 has a frame shape as a whole, and is positioned on the second surface 21b of the vibration plate 21, surrounding the plurality of piezoelectric elements 24 in plan view. That is, the sealing member 25 collectively seals the plurality of piezoelectric elements 24. With the sealing member 25 positioned surrounding the plurality of piezoelectric elements 24, a space occupied by the sealing member 25 on the vibration plate 21 (second surface 21b) can be reduced as compared with a structure in which the sealing member 25 individually surrounds each of the piezoelectric elements 24. As a result, miniaturization in a planar direction of the liquid discharge head 8 can be promoted.

Further, with the sealing member 25 positioned surrounding the plurality of piezoelectric elements 24 as a whole, the plurality of piezoelectric elements 24 can be arranged close to each other on the vibration plate 21 (second surface 21b), and high integration of the piezoelectric elements 24 in the planar direction of the liquid discharge head 8 can be achieved.

Furthermore, with the sealing member 25 positioned surrounding the plurality of piezoelectric elements 24 as a whole, a bonding surface area when the vibration plate 21 and the channel member 26 are bonded to each other via the sealing member 25 is reduced to the extent possible, suppressing the occurrence of defects in the sealing member 25. Thus, a connection reliability of the sealing member 25 is improved.

The sealing member 25 is made of a metal. The metal forming the sealing member 25 is preferably a metal having excellent resistance to the liquid supplied inside each pressure chamber 22 through the channel 26a of the channel member 26 and the opening 21c of the vibration plate 21. As such a metal, for example, gold (Au) or an alloy containing gold (Au) can be used. As the alloy containing gold (Au), for example, a gold (Au)-tin (Sn) alloy, a gold (Au)-silicon (Si) alloy, or a gold (Au)-germanium (Ge) alloy can be used. With the sealing member 25 being made of a metal, the resistance of the sealing member 25 to the liquid supplied inside each pressure chamber 22 is improved, further improving the connection reliability of the sealing member 25.

Note that the sealing member 25 may be made of a resin such as, for example, a benzocyclobutene resin, instead of a metal. When a resin such as a benzocyclobutene resin is used, the sealing member 25 can be formed and sealed at a low temperature as compared with when a metal is used, reducing a thermal load on the piezoelectric elements 24. In this case, there is the advantage of maintaining desired element characteristics of the piezoelectric elements 24 after sealing.

The channel member 26 is bonded onto the second surface 21b of the vibration plate 21 via the sealing member 25. The channel member 26 and the second surface 21b are bonded to each other via the sealing member 25 by, for example, diffusion bonding.

The channel member 26 includes the channel 26a that penetrates the channel member 26 in the thickness direction (Z axis direction). With the liquid discharge head 8 being a circulation-type liquid discharge head, the channel member 26 includes two channels 26a corresponding to one pressure chamber 22. One of the two channels 26a is a supply channel for supplying liquid to the pressure chamber 22 inside the head 8, and the other is a recovery channel for recovering liquid from the pressure chamber 22 inside the head 8. Further, the channel member 26 includes a cavity (no reference sign) for housing and sealing the piezoelectric element 24 on a lower surface (surface facing the second surface 21b) side.

The nozzle layer 27 is positioned on the bottom surface 8e side of the liquid discharge head 8 and closes a lower end side of the pressure chamber 22. The nozzle layer 27 includes the nozzles 28 respectively corresponding to the plurality of pressure chambers 22. The nozzle 28 is a through hole penetrating the nozzle layer 27 in a thickness direction (Z axis direction). The liquid supplied inside each pressure chamber 22 is discharged as a droplet from the nozzle 28 to the outside by pressure being applied to the pressure chamber 22 via the vibration plate 21 by the deformation of the piezoelectric elements 24.

Here, details of a bonding portion between the channel member 26 and the second surface 21b of the vibration plate 21 via the sealing member 25 will be further described with reference to FIGS. 3 and 4.

As illustrated in FIG. 4, the vibration plate 21 includes the opening 21c of a through hole connecting the channel 26a and each pressure chamber 22 at a position corresponding to the channel 26a of the second surface 21b. With the channel member 26 including two channels 26a corresponding to one pressure chamber 22, the vibration plate 21 includes two openings 21c connecting the two channels 26a and the corresponding pressure chamber 22 at positions corresponding to the two channels 26a of the second surface 21b.

As illustrated in FIGS. 3 and 4, the sealing member 25 includes a sealer 251 having a ring shape positioned between the second surface 21b of the vibration plate 21 and the channel member 26 and surrounding peripheral edges of the channel 26a and the opening 21c in plan view. With the channel member 26 including two channels 26a corresponding to one pressure chamber 22, the sealing member 25 includes two sealers 251 corresponding to one pressure chamber 22. The sealer 251 seals the peripheral edges of the channel 26a and the opening 21c. With the sealing member 25 including the sealers 251, the sealing of the plurality of piezoelectric elements 24 and the sealing of the peripheral edges of the channels 26a and the openings 21c are collectively performed by one sealing member 25, thereby promoting miniaturization in the planar direction of the liquid discharge head 8. The plurality of sealers 251 are coupled to each other to form part of the sealing member 25 having a frame shape as a whole, and thus the sealing of the plurality of piezoelectric elements 24 and the sealing of the peripheral edges of the channels 26a and the openings 21c can be performed at the same time in that section, thereby facilitating a reduction in sealing material.

As illustrated in FIG. 3, the sealing member 25 is formed into a rectangular frame shape including long side portions and short side portions in plan view. The long side portions of the sealing member 25 extend in the X axis direction. The short side portions of the sealing member 25 extend in the Y axis direction. A width W1 of at least part of the long side portions of the sealing member 25 is greater than a width W2 of the short side portions of the sealing member 25. In the example of FIG. 3, the sealers 251 having a ring shape are formed in part of each long side portion of the sealing member 25, and the width W1 corresponding to an outer diameter of the sealers 251 is greater than the width W2. With the width W1 being greater than the width W2, a bonding surface area per unit length of each long side portion of the sealing member 25 including the portion having the width W1 and the second surface 21b is greater than a bonding surface area per unit length of each short side portion of the sealing member 25 having the width W2 and the second surface 21b. A thermal stress caused by a difference in thermal expansion coefficients between the sealing member 25 and the vibration plate 21 tends to be greater in the long side portions than in the short side portions of the sealing member 25. In response, with the bonding surface area per unit length of each long side portion being greater than the bonding surface area per unit length of each short side portion of the sealing member 25, even when the thermal stress caused by the difference in thermal expansion coefficients between the sealing member 25 and the vibration plate 21 is more strongly applied to each long side portion than to each short side portion of the sealing member 25, the occurrence of breakage in each long side portion of the sealing member 25 is reduced. Accordingly, the connection reliability of the sealing member 25 is improved.

Corner portions of the sealing member 25 formed into the rectangular frame shape may each have a rounded shape as illustrated in FIG. 3. With the corner portions of the sealing member 25 being rounded, a concentration of thermal stress on the corner portions caused by the difference in thermal expansion coefficients between the sealing member 25 and the vibration plate 21 can be alleviated, thereby reducing the occurrence of breakage in the corner portions of the sealing member 25. This also improves the connection reliability of the sealing member 25.

Note that FIGS. 3 and 4 illustrate an example of the configuration of the liquid discharge head 8. The liquid discharge head 8 may further include a member other than the members illustrated in FIGS. 3 and 4.

### Other Embodiments

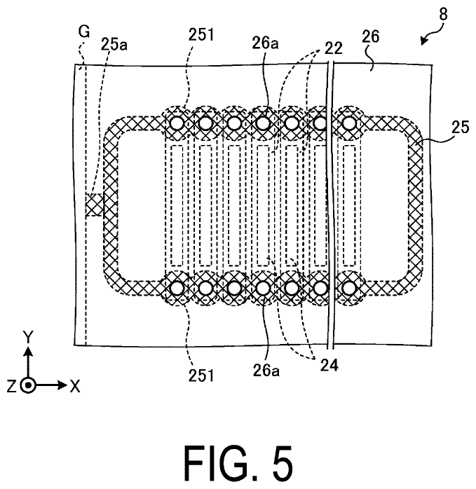

FIG. 5 is a plan view illustrating a schematic configuration of the liquid discharge head 8 according to a first alternate embodiment. As illustrated in FIG. 5, the sealing member 25 according to the first alternate embodiment is electrically connected to a ground electrode G (hatching omitted). The ground electrode G is, for example, formed on the second surface 21b (see FIG. 4) of the vibration plate 21 and is connected to a ground potential. The sealing member 25 is connected to such a ground electrode G via a ground wiring 25a.

Here, the liquid supplied inside each pressure chamber 22 through the channels 26a of the channel member 26 and the openings 21c of the vibration plate 21 contains, for example, a dispersing agent for dispersing components in the liquid. The dispersing agent contained in the liquid is charged and, when such a charge is accumulated by being electrically drawn to the sealing member 25 surrounding the peripheral edges of the channels 26a and the openings 21c, components in the liquid may aggregate at the sealing member 25 (sealers 251). On the other hand, in the first alternate embodiment, the sealing member 25 is connected to the ground electrode G, thereby releasing the charge accumulated in the sealing member 25 to the ground electrode G, and thus the aggregation of the components in the liquid at the sealing member 25 (sealers 251) is reduced.

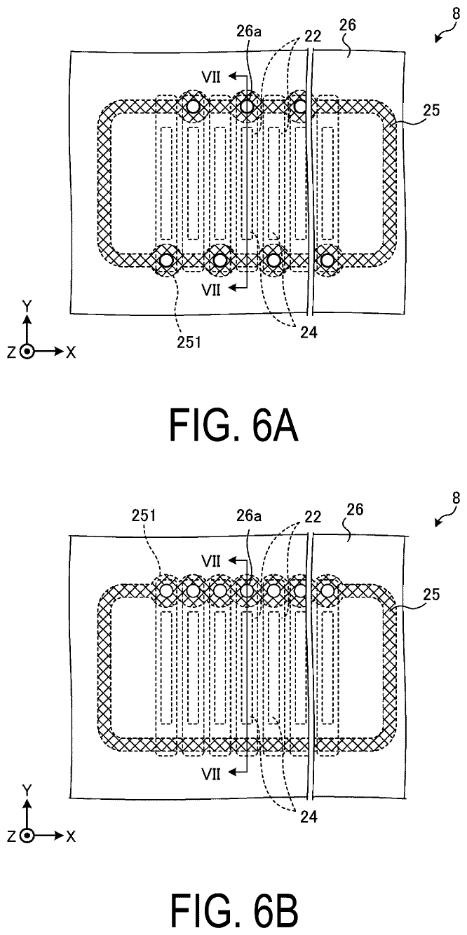

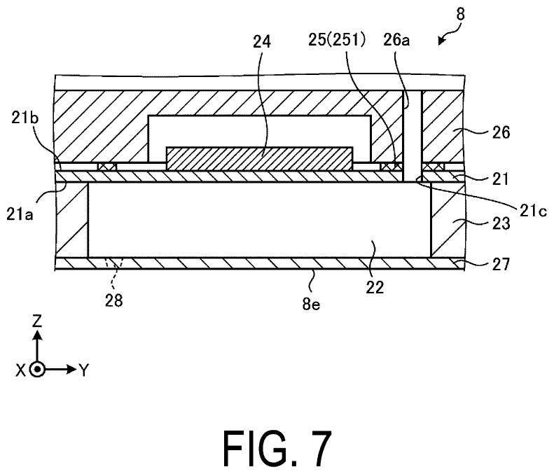

FIG. 6A is a plan view illustrating a schematic configuration of the liquid discharge head 8 according to a second alternate embodiment. FIG. 6B is a plan view illustrating a schematic configuration of the liquid discharge head 8 according to a third alternate embodiment. FIG. 7 is a cross-sectional view taken along line VII-VII illustrated in FIG. 6A or FIG. 6B. Each of the liquid discharge heads 8 illustrated in FIGS. 6A and 6B and FIG. 7 is a so-called non-circulation-type liquid discharge head that discharges a liquid supplied thereto without recovering the liquid. In such a case, a liquid, for example, ink, is supplied to the liquid discharge head 8 from a liquid tank (not illustrated). The liquid discharge head 8 discharges the liquid supplied from the liquid tank without circulating and recovering the liquid.

With the liquid discharge head 8 being a non-circulation-type liquid discharge head, the channel member 26 includes one channel 26a corresponding to one pressure chamber 22, as illustrated in FIGS. 6A and 6B. Such a channel 26a is a supply channel for supplying liquid to the pressure chamber 22 inside the head 8.

As illustrated in FIG. 7, the vibration plate 21 includes the opening 21c of the through hole connecting the channel 26a and each pressure chamber 22 at a position corresponding to the channel 26a of the second surface 21b. The opening 21c in the second alternate embodiment illustrated in FIG. 6A and in the third alternate embodiment illustrated in FIG. 6B may be formed by connecting one pressure chamber 22 and one channel 26a corresponding thereto. Accordingly, there is no need to continuously form the opening 21c corresponding to each pressure chamber 22 in both long side portions of the sealing member 25 as in the example of the embodiment. Accordingly, in the second alternate embodiment, the openings 21c and the sealers 251 are alternately arranged on both long side portions of the sealing member 25 in correspondence with each pressure chamber 22. In the third alternate embodiment, the openings 21c and the sealers 251 are arranged continuously on one long side portion of the sealing member 25 in correspondence with each pressure chamber 22 as in the example of the embodiment.

As illustrated in FIGS. 6A and 6B and FIG. 7, the sealing member 25 includes the sealers 251 having a ring shape positioned between the second surface 21b of the vibration plate 21 and the channel member 26 and surrounding the peripheral edges of the channels 26a and the openings 21c in plan view. The sealer 251 seals the peripheral edges of the channel 26a and the opening 21c. With the sealing member 25 including the sealers 251, the sealing of the plurality of piezoelectric elements 24 and the sealing of the peripheral edges of the channels 26a and the openings 21c are collectively performed by one sealing member 25. Thus, miniaturization in the planar direction of the liquid discharge head 8 is promoted.

Note that, in the second alternate embodiment, the openings 21c and the sealers 251 are alternately arranged on both long side portions of the sealing member 25, and thus areas between the sealers 251 spaced apart from each other as compared with the example of the embodiment and the third alternate embodiment may be connected by, for example, a pattern having a desired width equal to or wider than the width of the short side portions of the sealing member 25 to form the sealing member 25 having a framed shape. In such a second alternate embodiment, there is the advantage of having more leeway in the arrangement and routing of the channels 26a, resulting in a high degree of freedom in the design of the channels 26a in the head.

In the third alternate embodiment, the openings 21c and the sealers 251 are arranged continuously on one long portion side of the sealing member 25, and thus the sealer 251 may be formed in the same manner as the long side portion in the example of the embodiment. In the third alternate embodiment, the arrangement and routing of the channels 26a can be made uniform in the head as a whole, resulting in the advantage of facilitating the design and manufacture of the channels 26a and the smooth supply and discharge of ink in the entire head.

As described above, the liquid discharge head (for example, liquid discharge head 8) according to the embodiment includes a vibration plate (for example, vibration plate 21), a plurality of pressure chambers (for example, pressure chambers 22), a plurality of piezoelectric elements (for example, piezoelectric elements 24), and a sealing member (for example, sealing member 25). The vibration plate includes a first surface (for example, first surface 21a) and a second surface (for example, second surface 21b) positioned opposite to the first surface. The plurality of pressure chambers face the first surface and are positioned side by side in one direction (for example, X axis direction). The plurality of piezoelectric elements are positioned on the second surface of the vibration plate and respectively overlap the plurality of pressure chambers in plan view. The sealing member is a sealing member having a frame shape and positioned on the second surface of the vibration plate, surrounding the plurality of piezoelectric elements. Thus, according to the liquid discharge head of the embodiment, miniaturization in a planar direction of the liquid discharge head can be promoted.

The liquid discharge head according to the embodiment may further include a channel member (for example, channel member 26) bonded onto the second surface of the vibration plate via a sealing member and including a channel (for example, channel 26a) penetrating in a thickness direction. The vibration plate may include an opening (for example, opening 21c) of a through hole connecting the channel and each of the pressure chambers at a position corresponding to the channel on the second surface. The sealing member may include a sealer (for example, sealer 251) positioned between the second surface of the vibration plate and the channel member and surrounding peripheral edges of the channel and the opening in plan view. Thus, according to the liquid discharge head of the embodiment, the sealing of the plurality of piezoelectric elements and the sealing of the peripheral edges of the channel and the opening are collectively performed by one sealing member, promoting miniaturization in the planar direction of the liquid discharge head.

The sealing member may be formed into a rectangular frame shape including long side portions and short side portions in plan view. A width of at least part of the long side portions of the sealing member (for example, width W1 including the sealer) is greater than a width of the short side portions of the sealing member (for example, width W2). Thus, according to the liquid discharge head of the embodiment, even when the thermal stress caused by a difference in thermal expansion coefficients between the sealing member and the vibration plate is more strongly applied to each long side portion than to each short side portion of the sealing member, the occurrence of breakage in each long side portion of the sealing member is reduced. Accordingly, the connection reliability of the sealing member is improved.

Corner portions of the sealing member formed into the rectangular frame shape may each have a rounded shape. Thus, according to the liquid discharge head of the embodiment, a concentration of thermal stress caused by a difference in thermal expansion coefficients between the sealing member and the vibration plate at the corner portions can be alleviated, reducing the occurrence of breakage in the corner portions of the sealing member. Accordingly, the connection reliability of the sealing member is improved.

The sealing member may be made of a metal. The metal may be gold (Au) or an alloy including gold (Au). Thus, according to the liquid discharge head of the embodiment, a resistance of the sealing member against the liquid supplied inside each pressure chamber is improved, further improving the connection reliability of the sealing member.

The sealing member may be electrically connected to a ground electrode. Thus, according to the liquid discharge head of the embodiment, an electric charge accumulated in the sealing member is released to the ground electrode, reducing aggregation of components in the liquid at the sealing member.

The sealing member may be made of a benzocyclobutene resin. Thus, according to the liquid discharge head of the embodiment, the sealing member can be formed and sealed at a low temperature as compared with that when a metal is used, reducing a thermal load on the piezoelectric elements. In this case, there is the advantage of maintaining desired element characteristics of the piezoelectric elements after sealing.

Further effects and other embodiments can be readily derived by those skilled in the art. Thus, a wide variety of aspects of the present disclosure are not limited to the specific details and representative embodiments represented and described above. Accordingly, various changes are possible without departing from the spirit or scope of the general inventive concepts defined by the appended claims and their equivalents.

1. A liquid discharge head comprising:
a vibration plate comprising a first surface and a second surface;
at least two pressure chambers facing the first surface and located in one direction;
at least two piezoelectric elements on the second surface wherein, in a plan view, a first piezoelectric element overlaps a first pressure chamber and a second piezoelectric element overlaps a second pressure chamber, and
a scaling member surrounding the at least two piezoelectric elements in the plan view.

2. The liquid discharge head according to claim 1, further comprising:
a channel member comprising a first channel and a second channel penetrating the channel member in a thickness direction, wherein
the vibration plate comprises a first through-hole and a second through-hole,
the first through-hole connects the first channel and the first pressure chamber,
the second through-hole connects the second channel and the second pressure chamber, and
the sealing member comprises a sealing portion surrounding each of an opening of the first through-hole and an opening of the second through-hole.

3. The liquid discharge head according to claim 1, wherein the sealing member comprises a first side portion and a second side portion in the plan view, and
the long the first side portion comprises the portion which is greater than a width of the second side portion.

4. The liquid discharge head according to claim 1, wherein
the sealing member comprises a corner portion, wherein the corner portion has a round shape.

5. The liquid discharge head according to claim 1, wherein the sealing member contains a metal.

6. The liquid discharge head according to claim 5, wherein the metal is gold or an alloy containing gold.

7. The liquid discharge head according to claim 5, wherein the sealing member is electrically connected to a ground electrode.

8. The liquid discharge head according to claim 1, wherein the sealing member contains a benzocyclobutene resin.

9. A recording device comprising the liquid discharge head according to claim 1.

10. The liquid discharge head according to claim 1, wherein
the sealing member comprises a first side portion and a second side portion in the plain view, and
the first side portion comprise the sealing portion.

11. The liquid discharge head according to claim 10, wherein
the first side portion is longer than the second side portion.

12. The liquid discharge head according to claim 1, wherein
the first pressure chamber comprises both ends in the longitudinal direction, and
the sealing member at least partially overlaps the both ends in the plan view.

13. The liquid discharge head according to claim 2, wherein
the channel member comprises a recessed portion with an opening at a surface facing the second surface.
the first piezoelectric element is between the recessed portion and the first pressure chamber.

14. The liquid discharge head according to claim 13, wherein
at least a portion of the first piezoelectric element is located inside the recessed portion.
